(19) United States
(12) Patent Application Publication
(10) Pub. No.: US 2023/0401528 A1
(43) Pub. Date: Dec. 14, 2023

(54) CALCULATING RETURN WINDOW

(71) Applicant: Capital One Services, LLC, McLean, VA (US)

(72) Inventors: Leeyat Bracha Tessler, Arlington, VA (US); Abdelkader M'Haamed Benkreira, Washington, DC (US); Shabnam Kousha, Washington, DC (US)

(21) Appl. No.: 17/839,585

(22) Filed: Jun. 14, 2022

(51) Int. Cl. G06Q 10/08; G06Q 30/02

(52) U.S. Cl. CPC G06Q 10/0837; G06Q 30/0201

(57) ABSTRACT

Disclosed embodiments pertain to systems and methods of facilitating product return. A product purchased by a user from a merchant can be determined from transaction data of the user. A return window for the product can be predicted from one or more of data from merchant websites, industry standards, or transaction data. Further, the likelihood that a product is a candidate for return can be predicted based on the transaction data. If the product is determined to be a candidate for return, the user can be notified of the return window for the product and a confidence score associated with the window. Refund timeliness can also be determined or inferred based on transaction data and provided to the user. Subsequently, transaction data can be monitored, and the user can be alerted if credit is not received after a predetermined time or the credit is less than expected.

### BACKGROUND

The timing by which a product can be returned to a seller is often referred to as a “return window.” Return windows can differ from merchant to merchant or from product to product. Finding information on return windows can be a laborious process. Oftentimes, customers who want to make returns can risk going outside of the return windows because intentions to make returns were not present at the time of purchase so return policies were not acquired. Even if purchases are returned, products purchased with a charge account can take days to be credited back (e.g., to be refunded). This is primarily because refund requests also go through a payment network similar to authorization requests to make purchases but in reverse. Having to check whether refunds have been credited back can be an inconvenience, especially if it is unclear how long refund processes take.

### SUMMARY

The following presents a simplified summary to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description presented later.

According to one aspect, disclosed embodiments can include a system that comprises a processor coupled to a memory that includes instructions that, when executed by the processor, cause the processor to identify a product purchased by a user from a merchant from transaction data of the user and predict a return window of the merchant for the product with a first machine learning model trained with one or more of data scraped from merchant websites, industry standards, or transaction data that captures time between when products are purchased, and a credit is issued for return of the products. In this instance, the first machine learning model can output a return window value and a confidence score that captures the likelihood that the return window is correct. Further, the instructions can cause the processor to predict the likelihood that the product is a return candidate with a second machine learning model trained on transaction data that captures purchase debits and return credits for products and merchants and notify the user of the return window and confidence score for the product when the likelihood the product is a return candidate satisfies a predetermined threshold. The instructions can further cause the processor to compare a debit amount to a credit amount for the product from transaction data of the user and alert the user when the credit amount is less than the debit amount for the product. The instructions can also cause the processor to analyze transaction data for a credit for a returned product and alert the user when the credit is undetected after a predetermined time. Further, the instructions can cause the processor to compute an aggregate function value of time between product purchase and refund for the merchant based on the transaction data, classify the merchant in terms of refund timeliness based on the aggregate function value, and notify the user of a merchant classification with the return window and confidence score. The instructions can also cause the processor to classify the merchant based on the aggregate function values of other merchants. The instructions can further cause the processor to infer a refund time for the product based on historical data that captures when a return was initiated and when a refund was credited to a user account for the merchant and notify the user of the refund time. In one instance, the instructions can cause the processor to predict the return window based on product type or merchant category. Further, the instructions can cause the processor to notify the user of available methods and location of return for a merchant based on the return policy of the merchant. Furthermore, the instructions can cause the processor to predict the likelihood that the product is a candidate for return based on product return history of the user.

In accordance with another aspect, disclosed embodiments can include a method comprising executing, on a processor, instructions that cause the processor to perform operations associated with product return. The operations include identifying a product purchased by a user from a merchant from transaction data of the user, predicting a return window of the merchant for the product with a first machine learning model trained with one or more of data scraped from merchant websites, industry standards, or transaction data that captures time between when products from merchants are purchased and a credit is issued for return of the products, wherein the first machine learning model outputs a return window that is a length of time and a confidence score that captures a likelihood that the return window is correct, predict a likelihood that the product is a candidate for return with a second machine learning model trained on transaction data that captures purchase debits and return credits for products and merchants, and return history of the user identifying a product purchased by a user from a merchant from transaction data of the user, predicting a return window of the merchant for the product with a first machine learning model trained with data scraped from merchant websites, industry standards, and transaction data that captures time between when products from merchants are purchased and a credit is issued for return of the products, wherein the first machine learning model outputs a return window that is a length of time and a confidence score that captures a likelihood that the return window is correct, predict a likelihood that the product is a candidate for return with a second machine learning model trained on transaction data that captures purchase debits and return credits for products and merchants, and return history of the user; and notifying the user of the return window and confidence score for the product when the likelihood the product is a candidate for return satisfies a predetermined threshold. The method further comprises searching the transaction data of the user for a credit for a product designated as returned and alerting the user when the credit is undetected after a predetermined time. The method can also comprise comparing a debit amount and a credit amount associated with purchase and return of the product from the transaction data of the user and alerting the user if the debit amount differs from the credit amount. Further, the method can comprise inferring a refund time for the product, with a third machine learning model, based on historical data that captures when a return was initiated and when a refund was credited to a user account for the merchant and notifying the user of the refund time. In one instance, the operations can further comprise predicting the return window based on product type or merchant category. The operations can also comprise notifying the user of available return methods and locations for a merchant based on a return policy of the merchant, and notifying the user comprises adding the return window and confidence score to the transaction data.

According to yet another aspect, disclosed embodiments can include a computer-implemented method. The method can comprise identifying a product purchased by a user from a merchant based on transaction data of the user from a financial institution, predicting a return window of the merchant for the product with a first machine learning model trained with one or more of data scraped from merchant websites, industry standards, and historical transaction data of multiple users, wherein the first machine learning model outputs a return window that is a number of days and a confidence score that captures a likelihood that the return window is correct, predicting a likelihood that the product is a return candidate with a second machine learning model trained on the historical transaction data of the user capturing purchase debits and return credits for products and merchants and product type, and informing the user of the return window and confidence score for the product when the likelihood the product is a return candidate satisfies a predetermined threshold. The method also comprises computing one of a minimum, maximum, or average time between product purchase and refund for the merchant based on historical transaction data, classifying the merchant in terms of refund timeliness based on the time, and informing the user of a merchant classification with the return window and confidence score. The method further comprises analyzing the transaction data of the user for a credit for the product when the product is designated as returned by the user and alerting the user when the credit is undetected after a predetermined time. Furthermore, the method can comprise comparing a debit amount and a credit amount from the transaction data after the credit is detected and alerting the user when the credit amount is less than the debit amount.

To the accomplishment of the foregoing and related ends, certain illustrative aspects of the claimed subject matter are described herein in connection with the following description and the annexed drawings. These aspects indicate various ways in which the subject matter can be practiced, all of which are intended to be within the scope of the disclosed subject matter. Other advantages and novel features may become apparent from the following detailed description when considered in conjunction with the drawings.

### BRIEF DESCRIPTION OF THE DRAWINGS

FIG. 1 illustrates an overview of an example implementation in accordance with one or more embodiments described herein.

FIG. 2 illustrates a block diagram of an example, non-limiting return window calculation system in accordance with one or more embodiments described herein.

FIG. 3 illustrates a block diagram of another example, non-limiting return window calculation system in accordance with one or more embodiments described herein.

FIG. 4 illustrates a flow diagram of an example, non-limiting computer-implemented method in accordance with one or more embodiments described herein.

FIG. 5 illustrates a flow diagram of another example, non-limiting computer-implemented method in accordance with one or more embodiments described herein.

FIG. 6 illustrates a flow diagram of another example, non-limiting computer-implemented method in accordance with one or more embodiments described herein.

FIG. 7 illustrates a flow diagram of another example, non-limiting computer-implemented method in accordance with one or more embodiments described herein.

FIG. 8 illustrates a flow diagram of another example, non-limiting computer-implemented method in accordance with one or more embodiments described herein.

FIG. 9 is a block diagram illustrating a suitable operating environment for aspects of the subject disclosure.

### DETAILED DESCRIPTION

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Instead, the intention is to cover all modifications, equivalents, and alternatives falling within the spirit and scope of the specification and claimed subject matter.

When a consumer makes a purchase, there is often a “return window” that defines timing criteria regarding the return of the purchased product(s). Details disclosed herein generally pertain to identifying and calculating a return window related to a purchase. People can miss return windows for products they may want to return, especially with a busy schedule. A product can be a service or an item in physical, virtual, or cyber form. Even if returns are made, it can still be inconvenient to check if a refund amount is credited back to the consumer's account. Financial institutions that issue charge accounts used to make purchases often do not track details of specific products purchased by customers. Thus, transaction history generally does not show the type or price of products purchased and instead shows the total amount of a transaction. Through payment networks, financial institutions can receive information such as transaction data such as date and time of purchases, merchant information such as merchant category code (MCC), and location data indicating the type of retailer, such as whether a transaction was made with an online retailer or in-person. However, this information can be insufficient to calculate a return window for a purchased product because a retailer (e.g., a merchant) can sell different types of products that can have different return windows (e.g., product-specific). Also, not knowing the cost of individual products makes it difficult for financial institutions to figure out whether a refunded amount is an expected amount because a returned product can be part of a larger transaction containing a plurality of products.

Embodiments herein can collect information on specific products purchased by a user. For example, customers who opt-in can share their transaction data to use the disclosed embodiments. In addition, the embodiments herein can track transactions (e.g., purchase and return information) and credit backs (e.g., refund information) to calculate return windows and send notifications to remind users to make returns within the return windows, e.g., if there is a probability that the user would likely want to return. Machine learning can be used to notify users who are likely to make returns based on their frequency of getting credit back and notify of merchant types that customers typically return (e.g., send notification for purchases at retail stores and not for grocery stores).

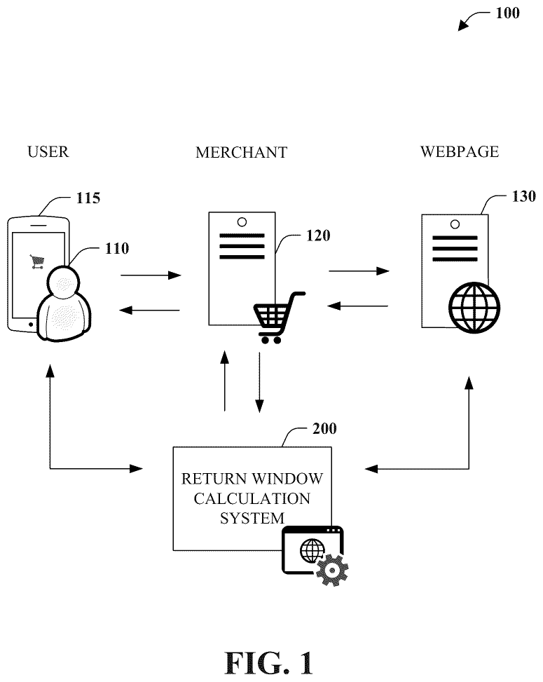

Referring to FIG. 1 to illustrate an overview of an example implementation 100 in accordance with one or more embodiments described herein. User 110 (e.g., a customer) can make purchases from merchant 120 using electronic device 115 (e.g., mobile device, computer, laptop, tablet, IoT (Internet of Things) device). Information on products purchased, such as information on transactions (e.g., purchase and return information) and credit backs (e.g., refund information), can be collected by return window calculation system 200 (e.g., return window calculating system) via an application or browser extension installed on the electronic device 115. For example, the application can be a payment application, and the browser extension can also be used with a virtual card number to make payments. Both the payment application and the browser extension can be used to make payments, collect purchase transaction data, and retain an electronic copy of the purchase receipt, thereby obtaining information, such as the products purchased, the merchant data, the date or time of the purchase, and the purchase amount of the products. The payment application and the browser extension can also be used to collect returned transaction data and retain an electronic copy of the return receipt, thereby obtaining information, such as the products returned, the merchant providing the credit back (e.g., the source and destination of the refund), the date or time of the return, and the amount to be credited back, among other things.

By tracking transactions and credit backs, the average, minimum, and maximum number of days between the transaction and credit back can be determined. For example, the return window calculation system 200 can track and display purchase dates and return dates in the user 110's transaction history (e.g., a graphical user interface (GUI)). The return window calculation system 200 can determine the timing of refunds (e.g., the number of days to receive a refund) based on the length of time from initiation of returns until refunds are credited back. The number of days between a return date (e.g., date return initiated) and a refund date (e.g., date refund credited back or date refund received) is the timing of refund (e.g., how long it takes to receive a refund). Thus, the minimum number of days between the transaction and credit back can be the same as the timing of the refund because the purchase date and the return date can be the same date. The difference between the maximum number of days between the transaction and credit back and the timing of the refund (e.g., the number of days to receive a refund) can be the return window, assuming that the maximum number of days between the transaction and credit back is based on returns initiated on the last day of a return window (e.g., number of days from the purchase date to make a return).

Depending on the length of the return windows and the buying or returning habits of the user 110, the return window calculation system 200 can modify the frequency and number of notifications sent to the user 110 through the electronic device 115 to remind the user 110 to make returns within the return windows. For example, if a return window is long, notifications can be spread further apart, and the number of notifications can increase as the probability that the user will return a product. If the probability that the user will return a product is zero, notifications to make returns do not need to be sent. However, the return window calculation system 200 can still display information on return windows for all products purchased by the user 110 in the user 110's transaction history. For example, the transaction history can display last-day-to-return dates along with respective products purchased. The transaction history can also display a hyperlink opening to a new screen providing information on return policy, including return window, methods to return, and locations to return, among other things.

In the example, the probability of whether the user 110 will return a product can be determined based on tracking and analyzing which type of products, category of merchants, demographics of the user, or type of retailers the user 110 typically returns. For example, the user 110 can have a higher probability of returning clothing ordered from an online merchant than returning books purchased from a bookstore. As another example, the user 110 can have a higher probability of returning items purchased at retail stores than grocery stores. Machine learning can be used to detect the frequency at which the user 110 is getting credit back and send notifications for purchases that have a high probability of being returned meeting a predetermined threshold. If the probability that the user 110 will return a product meets a predetermined threshold, the product can be considered (e.g., identified) as a return candidate, and notifications can be sent to the user 110 to remind the user 110 to return this return candidate (e.g., product). Frequency and method of notification delivery can also be triggered upon the level of probability determined.

The return window calculation system 200 can also search webpage 130 for the merchant 120's return policy to obtain information on return windows. In examples, industry standards for return windows can differ between the type of product, category of merchant, and type of retailer. Industry standards for return windows can be determined by analyzing return policies of similar merchants (e.g., similar category of a merchant having similar MCC and similar type of retailer) for similar (or comparable) products.

In addition, the return window calculation system 200 can render the timing of refunds to the user 110 by displaying the timing of refunds in the user 110's transaction history. The user 110 can be alerted if a refund amount differs from the expected amount (e.g., total purchased amount including tax). It is appreciated that information or notifications can be rendered in various ways. As a non-limiting example, information or notifications can be rendered via email, text message, push notification (e.g., via a mobile application), browser notification (e.g., via a browser extension), graphical user interface (e.g., of a mobile application or online account) such as a display or pop-up notification, or a combination thereof.

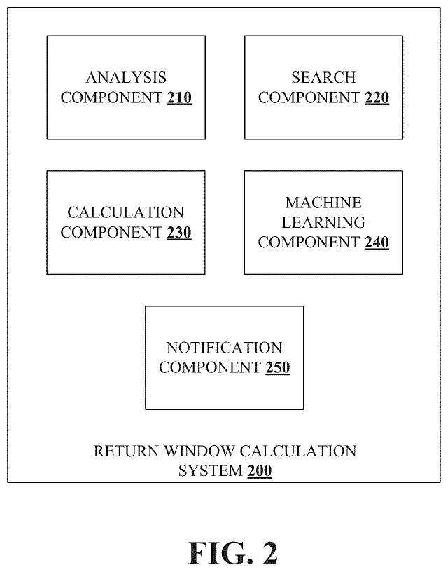

FIG. 2 illustrates a block diagram of an example, non-limiting return window calculation system 200 in accordance with one or more embodiments described herein. The return window calculation system 200 can comprise analysis component 210, search component 220, calculation component 230, machine learning component 240, and notification component 250. The analysis component 210 can identify a plurality of products purchased by the user 110 from the merchant 120. The user 110 can make purchases and returns using electronic device 115, which can be installed with an application or browser extension for making payments or collecting receipt information containing the products purchased or returned. The application or browser extension can be a separate component used by the return window calculation system 200. For example, the browser extension can be a virtual assistant that uses a virtual card number to make payments. The application or browser extension also can be a component integral to the return window calculation system 200.

Based on collected information on purchases and returns, the analysis component 210 can also analyze transactions (e.g., purchase and return information) and credit back (e.g., refund information) of returned products for the merchant 120 to determine an average, minimum, and maximum number of days between the transaction and the credit back. Purchase information can include the product purchased, the date or time of the purchase, and the amount paid for the product purchased. Return information can include the product returned, the date or time of the return, and the amount being credited back, among other things. The refund information can be information such as the source (and destination) of the refund (e.g., the merchant 120 who is providing the refund and to which account), the date or time the refund is credited back to the user 110's charge account, and the amount credited back, among other things.

The minimum number of days between the transaction and credit back (e.g., generally, minimum number of days) can mean that the purchase date and return date are the same dates. The maximum number of days between the transaction and the credit back (e.g., generally, maximum number of days) can mean that the return date is on the last day of the return window. The average number of days between the transaction and the credit back (e.g., average number of days) can be an average between the minimum number of days and the maximum number of days.

The timing of refund (e.g., the length of time from initiation of returns until refunds are credited back) can be the same as the minimum number of days because the purchase date and the return date are the same dates. The return window can be calculated based on the difference between the maximum number of days and the minimum number of days. Being that the timing of the refund can be the same as the minimum number of days, the return window can also be calculated based on the difference between the maximum number of days and the timing of the refund.

The analysis component 210 can also compare the average, minimum, and maximum number of days between the transaction and the credit back for the merchant 120 with similar merchants in that merchant category (e.g., merchants that sell the same or similar products, merchants within the same MCC) to calculate a credit back return window (e.g., return window calculated from information on credit back). The search component 220 can search online for a return policy for the merchant 120 to determine a return policy return window for the merchant 120. The search component 220 can also search for return policies for merchants of similar merchant categories to determine an industry standards return window for merchants that sell the same or similar products or merchants within the same MCC.

The calculation component 230 can calculate with a percent confidence indicator a return window for each of the plurality of products based on the average, minimum, and maximum number of days, the credit back return window, the return policy return window, the industry standards return window, or a combination thereof. Return windows determined based on return policies can be reliable with a high percent confidence indicator. However, return policies can contain multiple numbers (or criteria/factors), which can cause the search component 220 to determine an incorrect number as the return window (e.g., the return policy return window). Therefore, it can be beneficial to calculate the return window using different sources and provide a percent confidence indicator. For example, if the return policy return window is similar to the credit back return window and the industry-standard return window, the return policy return window can have a relatively high percent confidence indicator (e.g., confidence score). If the return policy return window is different from the credit back return window, which is similar to the industry-standard return window, then either the credit back return window or the industry-standard return window can be used instead to provide the user 110 with a return window. In this example, the return policy return window can still be used. However, it can have a low percent confidence indicator.

Although information on the return window for the products purchased can be provided in the transaction history of a charge account via online or mobile application, reminders to make returns can also be sent to the user 110 to remind the user 110 to return products that the user 110 typically return (e.g., return candidates). The machine learning component 240 can invoke machine learning to identify a subset of the plurality of products as return candidates. The return candidates can be identified based on tracking and analyzing by the machine learning component 240, which type of products, category of merchants, or type of retailers the user 110 typically returns. The return candidates can have a probability that the user 110 will return with a predetermined threshold. For example, the machine learning component 240 can detect the frequency at which users (e.g., user 110) are receiving credit back so that notifications can be sent to users who are likely to return things for merchant types that the users typically make returns (e.g., send notifications for purchases at retail stores and not at grocery stores).

The notification component 250 can render notifications based on the frequency and probability of returning (e.g., return candidates) detected by the machine learning component 240. The notification component 250 can render a return timing notification for the return candidates including rendering the return window in the user 110's transaction history for the plurality of products. The return timing notification can also be rendered in other ways such as via email, text message, push notification, browser extension notification, or graphical user interface (e.g., of a mobile application or online account) as well as at predefined or predicted intervals. The mode of delivery can change based on urgency or timing, among other things. The return timing notification can be rendered on a frequency based on the return window length or buying and returning habits of the user 110. For example, if a return window is long, notifications can be spread further apart, and the number of notifications can increase as the probability that the user 110 will return a product increases. If the probability that the user 110 will return a product falls below a predetermined threshold, no notification is needed. However, information on the return window for this product that is not a return candidate can still be provided in the transaction history.

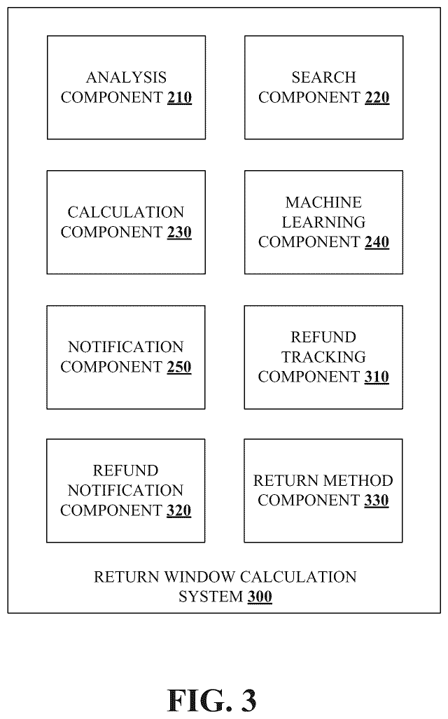

FIG. 3 illustrates a block diagram of another example, non-limiting return window calculation system 300 in accordance with one or more embodiments described herein. The return window calculation system 300 can further comprise refund tracking component 310, refund notification component 320, and return method component 330. The refund tracking component 310 can determine the timing of refunds by tracking the length of time from initiation of returns until refunds are credited back. As described, the timing of the refund can be the same as the minimum number of days between the transaction and credit back because the purchase date and the return date are the same dates. The refund tracking component 310 can also track whether a refund is received and whether the received amount is the expected amount. Upon receiving a credit back (e.g., a refund), the refund tracking component 310 can compare whether the amount credited back into the user 110's charge account is the expected amount from the expected source of the refund (e.g., the merchant 120) based on the return transaction data collected and the return receipt retained.

Upon initiation of returns, the refund notification component 320 can render the timing of refunds to the user 110. The refund notification component 320 can display the timing of the refunds in the transaction history or render notifications, for example, via email, text message, push notification, browser extension notification, or graphical user interface (e.g., of a mobile application or online account) such as a display or pop-up notification in addition to the transaction history. If the received amount (e.g., refunded amount) is different from the expected amount (e.g., purchased amount), the refund notification component 320 can also notify the user 120, asking whether the refund amount is correct.

In addition, the return method component 330 can render information on methods to return, such as in-person or by shipping, and locations to return based on information gathered from the return policy. The return method component 330 can analyze the return policy, e.g., searched by the search component 220, to determine the available methods and locations to return. Methods to return can be by shipping, in-person drop-off to a location that accepts returns for the merchant 120, or in-person return to the merchant 120. The return method component 330 can identify the methods to return including addresses provided for return. The return method component 330 can also search online maps for return addresses based on the available methods of return. For example, the return method component 330 can search for the nearest store location, relative to the location of the user 110, for the merchant 120. The return method component 330 can also search for the courier service locations or postal service locations closest to the user 110. The nearest store location, the closest courier service location, or the closest postal service location (e.g., generally, the nearest return location) can be where the user 110 is located or a place on the user 110's route. If the user 110 enables location tracking, the return method component 330 can track the location of the user 110, the usual route that the user 110 takes, or an upcoming route based on information from a calendar event if the user provides permission 110. With permission, the return method component 330 can search for the nearest return location based on the locations of the user or a place on the user 110's route to make returns and provide the best options such as the shortest distance or the fastest route. The shortest distance may not be the fastest route if traffic is congested. The return method component 330 can provide multiple return methods that user 110 can choose.

Various portions of the disclosed systems above and methods below can include or employ artificial intelligence (AI), machine learning (ML), or knowledge or rule-based components, sub-components, processes, means, methodologies, or mechanisms (e.g., support vector machines, neural networks, expert systems, Bayesian belief networks, fuzzy logic, data fusion engines, classifiers, . . . ). Such components, among others, can assist in automation of certain mechanisms or processes performed, thereby making portions of the systems and methods more adaptive as well as efficient and intelligent. By way of example, and not limitation, the machine learning component 240 can employ such mechanisms to identify a subset of the plurality of products as return candidates. In aspects, these AI, ML, and knowledge-based systems can be trained using historical data related to specific and/or similar consumers' purchase and return data.

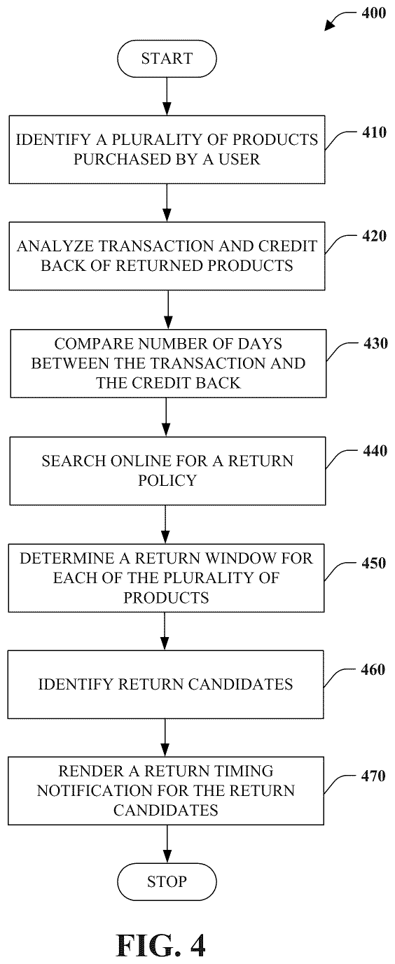

With reference to FIGS. 4 through 8, example, non-limiting computer-implemented methods 400, 500, 600, 700, and 800 are depicted. While, for purposes of simplicity of explanation, the methodologies shown herein, e.g., in the form of flow diagrams, are shown and described as a series of acts, it is to be understood and appreciated that the subject disclosure is not limited by the order of acts, as some acts can occur in a different order and/or concurrently with other acts from that shown and described herein. For example, those skilled in the art will understand and appreciate that a methodology could alternatively be represented as a series of interrelated states or events, such as in a state diagram. Moreover, not all illustrated blocks may be required to implement the methods described hereinafter. Further, each block or combination of blocks can be implemented by computer program instructions that can be provided to a processor to produce a machine, such that the instructions executing on the processor create a means for implementing functions specified by a flow chart block.

FIG. 4 illustrates a flow diagram of an example, non-limiting computer-implemented method 400 in accordance with one or more embodiments described herein. At 410, the computer-implemented method 400 can comprise identifying (e.g., via the analysis component), by the return window calculation system 200, a plurality of products purchased by the user 110 from the merchant 120. At 420, the computer-implemented method 400 can comprise analyzing (e.g., via the analysis component 210), by the return window calculation system 200, transaction and credit back of returned products for the merchant 120 to determine an average, minimum, and maximum number of days between the transaction and the credit back. At 430, the computer-implemented method 400 can comprise comparing (e.g., via the analysis component 210), by the return window calculation system 200, the average, minimum, and maximum number of days between the transaction and the credit back for the merchant 120 with similar merchants in that merchant category to calculate a credit back return window. At 440, the computer-implemented method 400 can comprise searching (e.g., via the search component 220), by the return window calculation system 200, online for a return policy for the merchant 120 and return policies for merchants of similar merchant categories to determine a return policy return window for the merchant 120 and an industry standards return window for the merchants of similar merchant categories, respectively. At 450, the computer-implemented method 400 can comprise calculating (e.g., via the calculation component 230), by the return window calculation system 200, with a percent confidence indicator a return window for each of the plurality of products based on the average, minimum, and maximum number of days, the credit back return window, the return policy return window, and the industry standards return window, or a combination thereof. At 460, the computer-implemented method 400 can comprise invoking (e.g., via the machine learning component 240), by the return window calculation system 200, machine learning to identify a subset of the plurality of products as return candidates. At 470, the computer-implemented method 400 can comprise rendering (e.g., via the notification component 250), by the return window calculation system 200, a return timing notification for the return candidates including rendering the return window in the user 110's transaction history for the plurality of products.

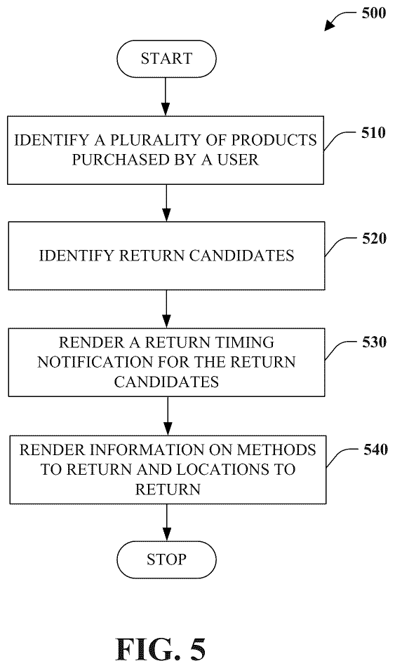

FIG. 5 illustrates a flow diagram of another example, non-limiting computer-implemented method 500 in accordance with one or more embodiments described herein. At 510, the computer-implemented method 500 can comprise identifying (e.g., via the analysis component 210), by the return window calculation system 300, a plurality of products purchased by the user 110 from the merchant 120. At 520, the computer-implemented method 500 can comprise invoking (e.g., via the machine learning component 240), by the return window calculation system 300, machine learning to identify a subset of the plurality of products as return candidates. At 530, the computer-implemented method 500 can comprise rendering (e.g., via the notification component 250), by the return window calculation system 300, a return timing notification for the return candidates including rendering the return window in the user 110's transaction history for the plurality of products. At 540, the computer-implemented method 500 can comprise rendering (e.g., via the return method component 330), by the return window calculation system 300, information on methods to return and locations to return based on information gathered from the return policy.

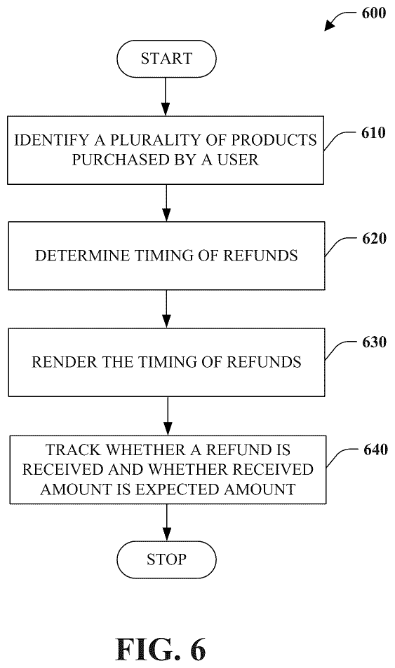

FIG. 6 illustrates a flow diagram of another example, non-limiting computer-implemented method 600 in accordance with one or more embodiments described herein. At 610, the computer-implemented method 600 can comprise identifying (e.g., via the analysis component 210), by the return window calculation system 300, a plurality of products purchased by the user 110 from the merchant 120. At 620, the computer-implemented method 600 can comprise determining (e.g., via the refund tracking component 310), by the return window calculation system 300, timing of refunds by tracking the length of time from initiation of returns until refunds are credited back. At 630, the computer-implemented method 600 can comprise rendering (e.g., via the refund notification component 320, by the return window calculation system 300, the timing of refunds to the user 110. At 640, the computer-implemented method 600 can comprise tracking (e.g., via the refund tracking component 310), by the return window calculation system 300, whether a refund is received and whether the received amount is the expected amount.

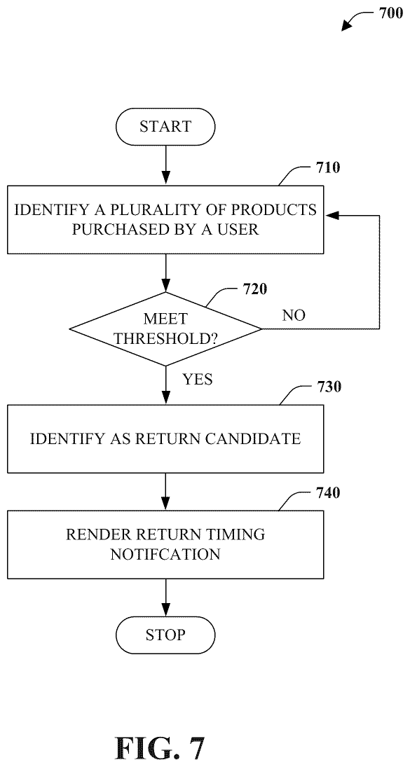

FIG. 7 illustrates a flow diagram of another example, non-limiting computer-implemented method 700 in accordance with one or more embodiments described herein. At 710, the computer-implemented method 700 can comprise identifying (e.g., via the analysis component 210), by the return window calculation system 300, a plurality of products purchased by the user 110 from the merchant 120. At 720, the computer-implemented method 700 can comprise determining (e.g., via the machine learning component 240), by the return window calculation system 300, whether a subset of the plurality of products meet a predetermined threshold based on the probability of being returned by the user 110. If yes, the subset of the plurality of products meets a predetermined threshold, then continues to 730. At 730, the computer-implemented method 700 can comprise identifying (e.g., via the machine learning component 240), by the return window calculation system 300, the subset of the plurality of products as return candidates. At 740, the computer-implemented method 700 can comprise rendering (e.g., via the notification component 250), by the return window calculation system 300, a return timing notification for the return candidates including rendering the return window in the user 110's transaction history for the plurality of products.

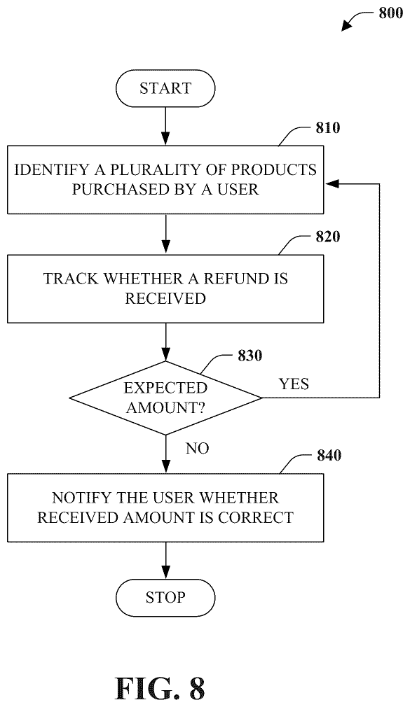

FIG. 8 illustrates a flow diagram of another example, non-limiting computer-implemented method 800 in accordance with one or more embodiments described herein. At 810, the computer-implemented method 800 can comprise identifying (e.g., via the analysis component 210), by the return window calculation system 300, a plurality of products purchased by the user 110 from the merchant 120. At 820, the computer-implemented method 800 can comprise tracking (e.g., via the refund tracking component 310), by the return window calculation system 300, whether a refund is received. At 830, the computer-implemented method 800 can comprise tracking (e.g., via the refund tracking component 310), by the return window calculation system 300, whether the received amount is the expected amount (e.g., whether the received refund amount is the expected refund amount). If no, the received amount is not the expected amount, then at 840, the computer-implemented method 800 can comprise notifying (e.g., via the refund notification component 320), by the return calculation system 300, the user 110 asking whether the received amount is correct.

The term “aggregate function” is a mathematical computation involving a range of values that results in a single summary value. Aggregate functions can include, but are not limited to, average, maximum, minimum, count, mode, range, and sum. The aggregate functions can be used to derive descriptive statistics in one instance.

As used herein, the terms “component” and “system,” as well as various forms thereof (e.g., components, systems, sub-systems . . . ), are intended to refer to a computer-related entity, either hardware, a combination of hardware and software, software, or software in execution. For example, a component can be but is not limited to being a process running on a processor, a processor, an object, an instance, an executable, a thread of execution, a program, and/or a computer. By way of illustration, both an application running on a computer and the computer can be a component. One or more components can reside within a process and/or thread of execution, and a component can be localized on one computer and/or distributed between two or more computers.

As used herein, the term “infer” or “inference” generally refer to the process of reasoning about or inferring states of a system, a component, an environment, or a user from one or more observations captured by way of events or data, among other things. Inference can be employed to identify a context or an action or used to generate a probability distribution over states, for example. An inference can be probabilistic. For example, computation of a probability distribution over states of interest can be based on a consideration of data or events. Inference can also refer to techniques employed for composing higher-level events from a set of events or data. Such inference can result in the construction of new events or new actions from a set of observed events or stored event data, whether or not the events are correlated in close temporal proximity, and whether the events and data come from one or several events and data sources.

The conjunction “or” as used in this description and appended claims is intended to mean an inclusive “or” rather than an exclusive “or,” unless otherwise specified or clear from the context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the preceding instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

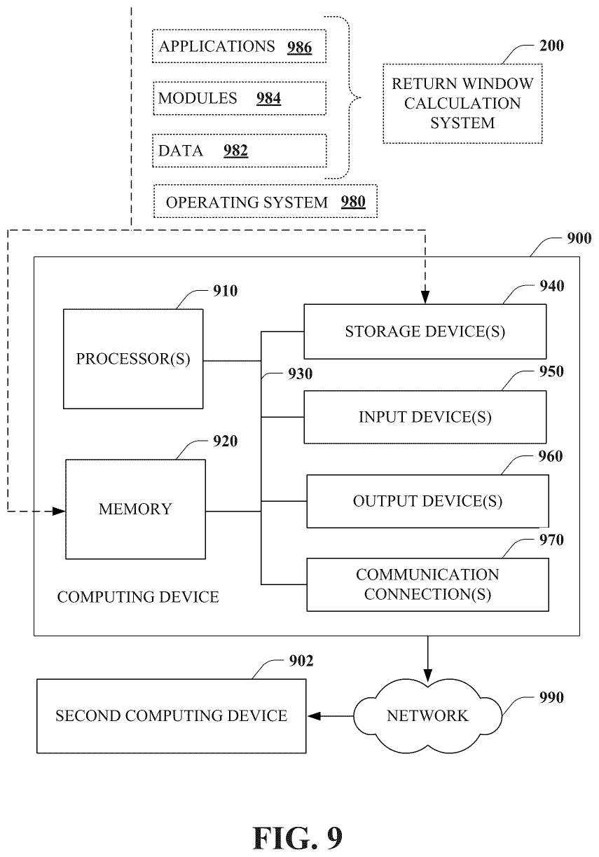

To provide a context for the disclosed subject matter, FIG. 9, as well as the following discussion, are intended to provide a brief, general description of a suitable environment in which various aspects of the disclosed subject matter can be implemented. However, the suitable environment is solely an example and is not intended to suggest any limitation on the scope of use or functionality.

While the above-disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things, that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, server computers, as well as personal computers, hand-held computing devices (e.g., personal digital assistant (PDA), smartphone, tablet, watch . . . ), microprocessor-based or programmable consumer or industrial electronics, and the like. Aspects can also be practiced in distributed computing environments where tasks are performed by remote processing devices linked through a communications network. However, some, if not all aspects, of the disclosed subject matter can be practiced on stand-alone computers. In a distributed computing environment, program modules can be located in one or both of local and remote memory devices.

With reference to FIG. 9, illustrated is an example computing device 900 (e.g., desktop, laptop, tablet, watch, server, hand-held, programmable consumer or industrial electronics, set-top box, game system, compute node, . . . ). The computing device 900 includes one or more processor(s) 910, memory 920, system bus 930, storage device(s) 940, input device(s) 950, output device(s) 960, and communications connection(s) 970. The system bus 930 communicatively couples at least the above system constituents. However, the computing device 900, in its simplest form, can include one or more processors 910 coupled to memory 920, wherein the one or more processors 910 execute various computer-executable actions, instructions, and or components stored in the memory 920.

The processor(s) 910 can be implemented with a general-purpose processor, a digital signal processor (DSP), an application-specific integrated circuit (ASIC), a field-programmable gate array (FPGA) or other programmable logic, discrete gate or transistor logic, discrete hardware components, or any combination thereof designed to perform the functions described herein. A general-purpose processor can be a microprocessor, but in the alternative, the processor can be any processor, controller, microcontroller, or state machine. The processor(s) 910 can also be implemented as a combination of computing devices, for example, a combination of a DSP and a microprocessor, a plurality of microprocessors, multi-core processors, one or more microprocessors in conjunction with a DSP core, or any other such configuration. In one embodiment, the processor(s) 910 can be a graphics processor unit (GPU) that performs calculations concerning digital image processing and computer graphics.

The computing device 900 can include or otherwise interact with a variety of computer-readable media to facilitate control of the computing device to implement one or more aspects of the disclosed subject matter. The computer-readable media can be any available media accessible to the computing device 900 and includes volatile and non-volatile media, and removable and non-removable media. Computer-readable media can comprise two distinct and mutually exclusive types: storage media and communication media.

Storage media includes volatile and non-volatile, removable and non-removable media implemented in any method or technology for storage of information such as computer-readable instructions, data structures, program modules, or other data. Storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid-state devices (e.g., solid-state drive (SSD), flash memory drive (e.g., card, stick, key drive . . . ) . . . ), or any other like mediums that store, as opposed to transmit or communicate, the desired information accessible by the computing device 900. Accordingly, storage media excludes modulated data signals as well as that which is described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

The memory 920 and storage device(s) 940 are examples of computer-readable storage media. Depending on the configuration and type of computing device, the memory 920 can be volatile (e.g., random access memory (RAM)), non-volatile (e.g., read only memory (ROM), flash memory . . . ), or some combination of the two. By way of example, the basic input/output system (BIOS), including basic routines to transfer information between elements within the computing device 900, such as during start-up, can be stored in non-volatile memory, while volatile memory can act as external cache memory to facilitate processing by the processor(s) 910, among other things.

The storage device(s) 940 include removable/non-removable, volatile/non-volatile storage media for storage of vast amounts of data relative to the memory 920. For example, storage device(s) 940 include, but are not limited to, one or more devices such as a magnetic or optical disk drive, floppy disk drive, flash memory, solid-state drive, or memory stick.

Memory 920 and storage device(s) 940 can include, or have stored therein, operating system 980, one or more applications 986, one or more program modules 984, and data 982. The operating system 980 acts to control and allocate resources of the computing device 900. Applications 986 include one or both of system and application software and can exploit management of resources by the operating system 980 through program modules 984 and data 982 stored in the memory 920 and/or storage device(s) 940 to perform one or more actions. Accordingly, applications 986 can turn a general-purpose computer 900 into a specialized machine in accordance with the logic provided thereby.

All or portions of the disclosed subject matter can be implemented using standard programming and/or engineering techniques to produce software, firmware, hardware, or any combination thereof to control the computing device 900 to realize the disclosed functionality. By way of example and not limitation, all or portions of the return window calculation system 200 can be, or form part of, the application 986, and include one or more modules 984 and data 982 stored in memory and/or storage device(s) 940 whose functionality can be realized when executed by one or more processor(s) 810.

In accordance with one particular embodiment, the processor(s) 910 can correspond to a system on a chip (SOC) or like architecture including, or in other words integrating, both hardware and software on a single integrated circuit substrate. Here, the processor(s) 910 can include one or more processors as well as memory at least similar to the processor(s) 910 and memory 920, among other things. Conventional processors include a minimal amount of hardware and software and rely extensively on external hardware and software. By contrast, a SOC implementation of a processor is more powerful, as it embeds hardware and software therein that enable particular functionality with minimal or no reliance on external hardware and software. For example, the return window calculation system 200 and/or functionality associated therewith can be embedded within hardware in a SOC architecture.

The input device(s) 950 and output device(s) 960 can be communicatively coupled to the computing device 900. By way of example, the input device(s) 950 can include a pointing device (e.g., mouse, trackball, stylus, pen, touchpad, . . . ), keyboard, joystick, microphone, voice user interface system, camera, motion sensor, and a global positioning satellite (GPS) receiver and transmitter, among other things. The output device(s) 960, by way of example, can correspond to a display device (e.g., liquid crystal display (LCD), light emitting diode (LED), plasma, organic light-emitting diode display (OLED) . . . ), speakers, voice user interface system, printer, and vibration motor, among other things. The input device(s) 950 and output device(s) 960 can be connected to the computing device 900 by way of wired connection (e.g., bus), wireless connection (e.g., Wi-Fi, Bluetooth, . . . ), or a combination thereof.

The computing device 900 can also include communication connection(s) 970 to enable communication with at least a second computing device 902 utilizing a network 990. The communication connection(s) 970 can include wired or wireless communication mechanisms to support network communication. The network 990 can correspond to a local area network (LAN) or a wide area network (WAN) such as the Internet. The second computing device 902 can be another processor-based device with which the computing device 900 can interact. In one instance, the computing device 900 can execute a return window calculation system 200 for a first function, and the second computing device 902 can execute a return window calculation system 200 for a second function in a distributed processing environment. Further, the second computing device can provide a network-accessible service that stores source code, and encryption keys, among other things that can be employed by the return window calculation system 200 executing on the computing device 900.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A system, comprising:
a processor coupled to a memory that includes instructions that, when executed by the processor, cause the processor to:
identify a product purchased by a user from a merchant from transaction data of the user;
predict a return window of the merchant for the product with a first machine learning model trained with data scraped from merchant websites, industry standards, or transaction data that captures time between when products are purchased and a credit is issued for return of the products, wherein the first machine learning model outputs a return window value and a confidence score that captures a likelihood that the return window is correct;
predict a likelihood that the product is a return candidate with a second machine learning model trained on transaction data that captures purchase debits and return credits for products and merchants; and
notify the user of the return window and confidence score for the product when the likelihood that the product is a return candidate satisfies a predetermined threshold.

2. The system of claim 1, wherein the instructions further cause the processor to:
compare a debit amount to a credit amount for the product from transaction data of the user; and
alert the user when the credit amount is less than the debit amount for the product.

3. The system of claim 1, wherein the instructions further cause the processor to:
analyze transaction data for a credit for a returned product; and
alert the user when the credit is undetected after a predetermined time.

4. The system of claim 1, wherein the instructions further cause the processor to:
compute an aggregate function value of time between product purchase and refund for the merchant based on the transaction data;
classify the merchant in terms of refund timeliness based on the aggregate function value; and
notify the user of a merchant classification with the return window and confidence score.

5. The system of claim 4, wherein the instructions further cause the processor to classify the merchant based on aggregate function values of other merchants.

6. The system of claim 1, wherein the instructions further cause the processor to:
infer a refund time for the product based on historical data that captures when a return was initiated and when a refund was credited to a user account for the merchant; and
notify the user of the refund time.

7. The system of claim 1, wherein the instructions further cause the processor to predict the return window based on product type or merchant category.

8. The system of claim 1, wherein the instructions further cause the processor to notify the user of available methods and locations of return for a merchant based on a return policy of the merchant.

9. The system of claim 1, wherein the instructions further cause the processor to predict the likelihood the product is a candidate for return based on product return history of the user.

10. A method, comprising:
executing, on a processor, instructions that cause the processor to perform operations associated with product return, the operations comprising:
identifying a product purchased by a user from a merchant from transaction data of the user;
predicting a return window of the merchant for the product with a first machine learning model trained with data scraped from merchant websites, industry standards, or transaction data that captures time between when products from merchants are purchased and a credit is issued for return of the products, wherein the first machine learning model outputs a return window that is a length of time and a confidence score that captures a likelihood that the return window is correct;
predicting a likelihood that the product is a candidate for return with a second machine learning model trained on transaction data that captures purchase debits and return credits for products and merchants, and return history of the user; and
notifying the user of the return window and confidence score for the product when the likelihood that the product is a candidate for return satisfies a predetermined threshold.

11. The method of claim 10, the operations further comprising:
searching the transaction data of the user for a credit for a product designated as returned; and
alerting the user when the credit is undetected after a predetermined time.

12. The method of claim 10, the operations further comprising:
comparing a debit amount and a credit amount associated with purchase and return of the product from the transaction data of the user; and
alerting the user if the debit amount differs from the credit amount.

13. The method of claim 10, the operations further comprising:
inferring a refund time for the product, with a third machine learning model, based on historical data that captures when a return was initiated and when a refund was credited to a user account for the merchant; and
notifying the user of the refund time.

14. The method of claim 10, the operations further comprising predicting the return window based on product type or merchant category.

15. The method of claim 10, the operations further comprising notifying the user of available return methods and locations for a merchant based on a return policy of the merchant.

16. The method of claim 10, wherein notifying the user comprises adding the return window and confidence score to the transaction data.

17. A computer-implemented method, comprising:
identifying a product purchased by a user from a merchant based on transaction data of the user from a financial institution;
predicting a return window of the merchant for the product with a first machine learning model trained with one or more of data scraped from merchant websites, industry standards, or historical transaction data of multiple users, wherein the first machine learning model outputs a return window that is a number of days and a confidence score that captures a likelihood that the return window is correct;
predicting a likelihood that the product is a return candidate with a second machine learning model trained on the historical transaction data of the user capturing purchase debits and return credits for products, merchant type, and product type; and
informing the user of the return window and confidence score for the product when the likelihood the product is a return candidate satisfies a predetermined threshold.

18. The computer-implemented method of claim 17, further comprising:
computing one of a minimum, maximum, or average time between product purchase and refund for the merchant based on historical transaction data;
classifying the merchant in terms of refund timeliness based on the time; and
informing the user of a merchant classification with the return window and confidence score.

19. The computer-implemented method of claim 17, further comprising:
analyzing the transaction data of the user for a credit for the product when the product is designated as returned by the user; and
alerting the user when the credit is undetected after a predetermined time.

20. The computer-implemented method of claim 19, further comprising:
comparing a debit amount and a credit amount from the transaction data after the credit is detected; and
alerting the user when the credit amount is less than the debit amount.
